(19) United States
(12) Patent Application Publication
(10) Pub. No.: US 2017/0094585 A1
(43) Pub. Date: Mar. 30, 2017

(54) METHOD AND APPARATUS FOR SUPPORTING SMALL CELL DISCOVERY IN WIRELESS COMMUNICATION SYSTEM

(71) Applicant: LG ELECTRONICS INC., Seoul (KR)

(72) Inventors: Daewook BYUN, Seoul (KR); Jian XU, Seoul (KR); Kyungmin PARK, Seoul (KR); Yunjung YI, Seoul (KR)

(73) Assignee: LG ELECTRONICS INC., Seoul (KR)

(21) Appl. No.: 15/122,821

(22) PCT Filed: Mar. 18, 2015
(86) PCT No.: PCT/KR2015/002623

§ 371 Date: Aug. 31, 2016

Related U.S. Application Data
(60) Provisional application No. 61/955,783, filed on Mar. 19, 2014.

(51) Int. Cl. H04W 48/08; H04W 72/04

(52) U.S. Cl. CPC H04W 48/08; H04W 72/0486; H04W 72/0426; H04W 84/045

(57) ABSTRACT

A method and apparatus for transmitting information on a cycle of a discovery signal transmitted by a small cell in a wireless communication system is provided. An evolved NodeB (eNB) of the small cell transmits the information on the cycle of the discovery signal to a macro cell, and transmits the discovery signal according to the cycle of the discovery signal. The cycle of the discovery signal can be determined on the basis of an offset value of a system frame number (SFN) of the small cell and an X2 interface delay.

### BACKGROUND OF THE INVENTION

Field of the Invention

The present invention relates to wireless communications, and more particularly, to a method and apparatus for supporting small cell discovery in a wireless communication system.

Related Art

Universal mobile telecommunications system (UMTS) is a 3rd generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Small cells using low power nodes are considered promising to cope with mobile traffic explosion in 3GPP LTE rel-12, especially for hotspot deployments in indoor and outdoor scenarios. A low-power node generally means a node whose transmission power is lower than macro node and base station (BS) classes, for example pico and femto evolved NodeB (eNB) are both applicable. Small cell enhancements for evolved UMTS terrestrial radio access (E-UTRA) and evolved UMTS terrestrial radio access network (E-UTRAN) will focus on additional functionalities for enhanced performance in hotspot areas for indoor and outdoor using low power nodes.

Various aspects may be considered for enhancement of a small cell. In particular, a discovery signal is discussed as a technology that is enabled to dynamically switch on/off a small cell in physical layer aspects. A macro cell needs to be informed of information on a discovery signal to be transmitted by a small cell, and a method of efficiently transmitting the information on the discovery signal to the macro cell may be required.

### SUMMARY OF THE INVENTION

The present invention provides a method and apparatus for supporting discovery of a small cell in a wireless communication system. The present invention provides a method in which a small cell informs a macro cell of a cycle of a discovery signal in various X2 procedures.

In an aspect, a method for transmitting information on a cycle of a discovery signal to be transmitted by a small cell in a wireless communication system is provided. The method includes transmitting the information on the cycle of the discovery signal to a macro cell, and transmitting the discovery signal according to the cycle of the discovery signal

In another aspect, an evolved NodeB (eNB) of a small cell, which transmits information on a cycle of a discovery signal in a wireless communication system is provided. The eNB includes a radio frequency (RF) unit configured to transmit and receive a wireless signal, and a processor connected to the RF unit. The processor is configured to transmit the information on the cycle of the discovery signal to a macro cell, and transmit the discovery signal according to the cycle of the discovery signal.

A macro cell may be efficiently informed of information on a cycle of a discovery signal to be transmitted by a small cell.

### BRIEF DESCRIPTION OF THE DRAWINGS

FIG. 1 shows LTE system architecture.

FIG. 2 shows a block diagram of architecture of a typical E-UTRAN and a typical EPC.

FIG. 3 shows a block diagram of a user plane protocol stack of an LTE system.

FIG. 4 shows a block diagram of a control plane protocol stack of an LTE system.

FIG. 5 shows an example of a physical channel structure.

FIG. 6 shows deployment scenarios of small cells with/without macro coverage.

FIGS. 7 and 8 shows examples of a method for transmitting information on a cycle of a discovery signal according to an embodiment of the present invention.

FIG. 9 shows another example of a method for transmitting information on a cycle of a discovery signal according to an embodiment of the present invention.

FIG. 10 shows another embodiment of a method for transmitting information on a cycle of a discovery signal according to an embodiment of the present invention.

FIGS. 11 and 12 shows another examples of a method for transmitting information on a cycle of a discovery signal according to an embodiment of the present disclosure.

FIG. 13 shows a block diagram of a wireless communication system to implement an embodiment of the present invention.

### DESCRIPTION OF EXEMPLARY EMBODIMENTS

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA-2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802-20, evolved UTRA (E-UTRA), etc. IEEE 802.16m is an evolution of IEEE 802.16e, and provides backward compatibility with an IEEE 802.16-based system. The UTRA is a part of a universal mobile telecommunication system (UMTS). 3rd generation partnership project (3GPP) long term evolution (LTE) is a part of an evolved UMTS (E-UMTS) using the E-UTRA. The 3GPP LTE uses the OFDMA in downlink and uses the SC-FDMA in uplink. LTE-advance (LTE-A) is an evolution of the 3GPP LTE.

For clarity, the following description will focus on the LTE-A. However, technical features of the present invention are not limited thereto.

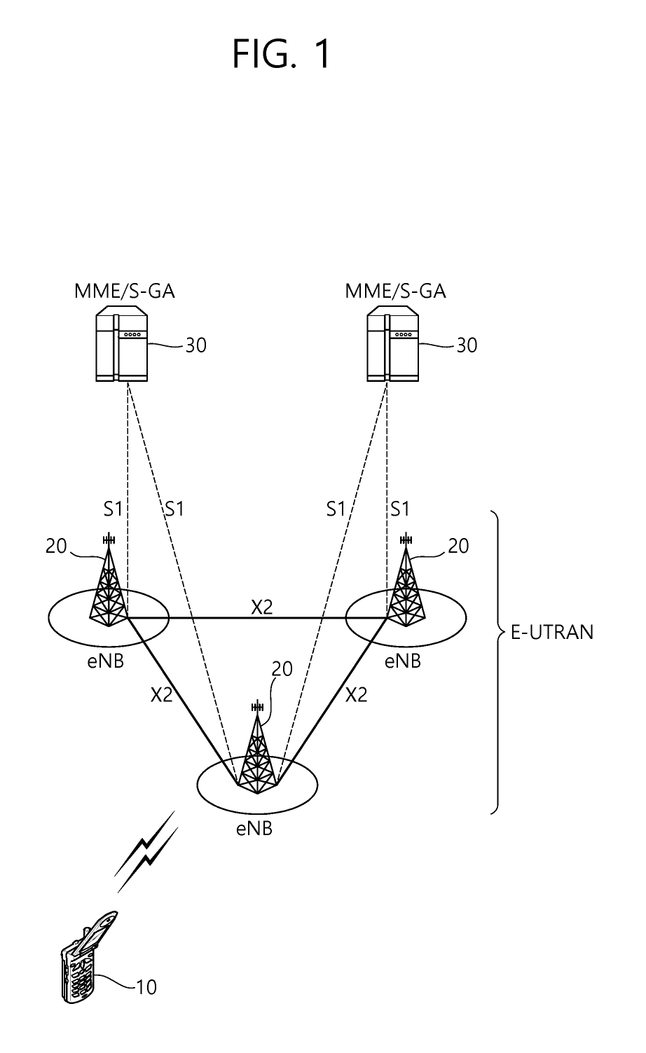

FIG. 1 shows LTE system architecture. The communication network is widely deployed to provide a variety of communication services such as voice over internet protocol (VoIP) through IMS and packet data.

Referring to FIG. 1, the LTE system architecture includes one or more user equipment (UE; 10), an evolved-UMTS terrestrial radio access network (E-UTRAN) and an evolved packet core (EPC). The UE 10 refers to a communication equipment carried by a user. The UE 10 may be fixed or mobile, and may be referred to as another terminology, such as a mobile station (MS), a user terminal (UT), a subscriber station (SS), a wireless device, etc.

The E-UTRAN includes one or more evolved node-B (eNB) 20, and a plurality of UEs may be located in one cell. The eNB 20 provides an end point of a control plane and a user plane to the UE 10. The eNB 20 is generally a fixed station that communicates with the UE 10 and may be referred to as another terminology, such as a base station (BS), an access point, etc. One eNB 20 may be deployed per cell.

Hereinafter, a downlink (DL) denotes communication from the eNB 20 to the UE 10, and an uplink (UL) denotes communication from the UE 10 to the eNB 20. In the DL, a transmitter may be a part of the eNB 20, and a receiver may be a part of the UE 10. In the UL, the transmitter may be a part of the UE 10, and the receiver may be a part of the eNB 20.

The EPC includes a mobility management entity (MME) and a system architecture evolution (SAE) gateway (S-GW). The MME/S-GW 30 may be positioned at the end of the network and connected to an external network. For clarity, MME/S-GW 30 will be referred to herein simply as a “gateway,” but it is understood that this entity includes both the MME and S-GW.

The MME provides various functions including non-access stratum (NAS) signaling to eNBs 20, NAS signaling security, access stratum (AS) security control, inter core network (CN) node signaling for mobility between 3GPP access networks, idle mode UE reachability (including control and execution of paging retransmission), tracking area list management (for UE in idle and active mode), packet data network (PDN) gateway (P-GW) and S-GW selection, MME selection for handovers with MME change, serving GPRS support node (SGSN) selection for handovers to 2G or 3G 3GPP access networks, roaming, authentication, bearer management functions including dedicated bearer establishment, support for public warning system (PWS) (which includes earthquake and tsunami warning system (ETWS) and commercial mobile alert system (CMAS)) message transmission. The S-GW host provides assorted functions including per-user based packet filtering (by e.g., deep packet inspection), lawful interception, UE Internet protocol (IP) address allocation, transport level packet marking in the DL, UL and DL service level charging, gating and rate enforcement, DL rate enforcement based on access point name aggregate maximum bit rate (APN-AMBR).

Interfaces for transmitting user traffic or control traffic may be used. The UE 10 is connected to the eNB 20 via a Uu interface. The eNBs 20 are connected to each other via an X2 interface. Neighboring eNBs may have a meshed network structure that has the X2 interface. A plurality of nodes may be connected between the eNB 20 and the gateway 30 via an SI interface.

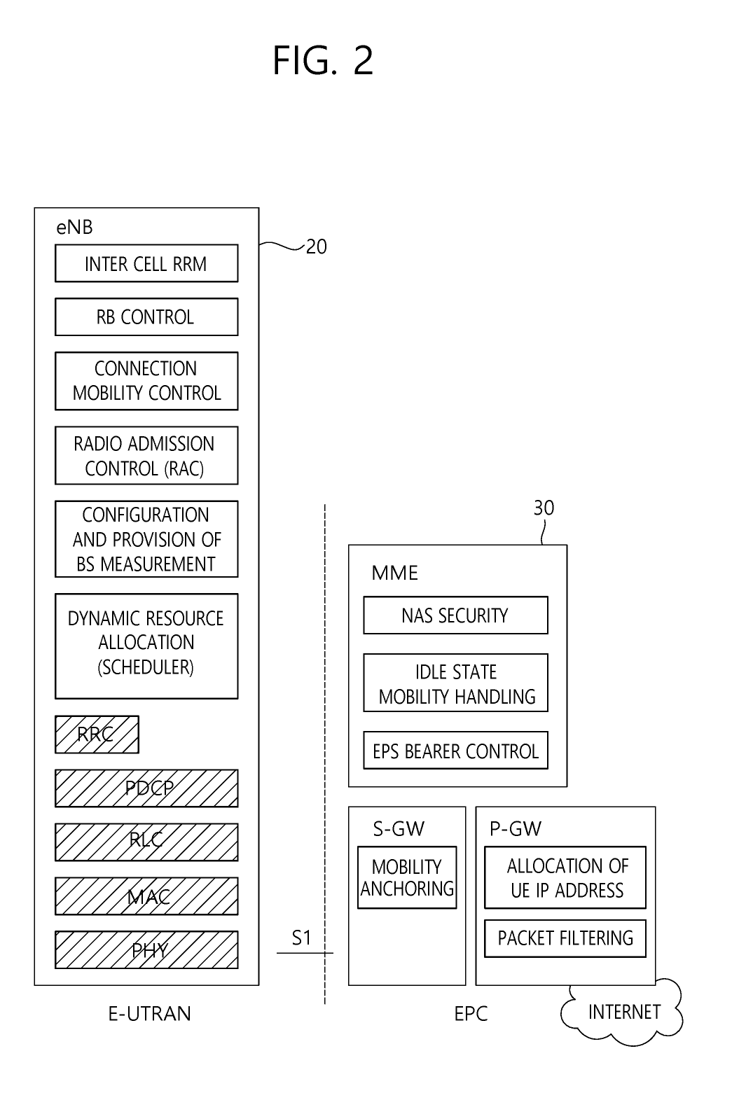

FIG. 2 shows a block diagram of architecture of a typical E-UTRAN and a typical EPC. Referring to FIG. 2, the eNB 20 may perform functions of selection for gateway 30, routing toward the gateway 30 during a radio resource control (RRC) activation, scheduling and transmitting of paging messages, scheduling and transmitting of broadcast channel (BCH) information, dynamic allocation of resources to the UEs 10 in both UL and DL, configuration and provisioning of eNB measurements, radio bearer control, radio admission control (RAC), and connection mobility control in LTE_ACTIVE state. In the EPC, and as noted above, gateway 30 may perform functions of paging origination, LTE_IDLE state management, ciphering of the user plane, SAE bearer control, and ciphering and integrity protection of NAS signaling.

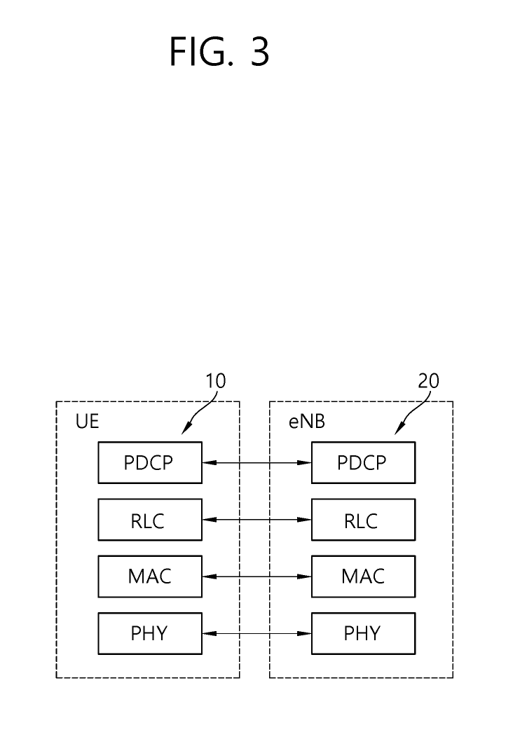

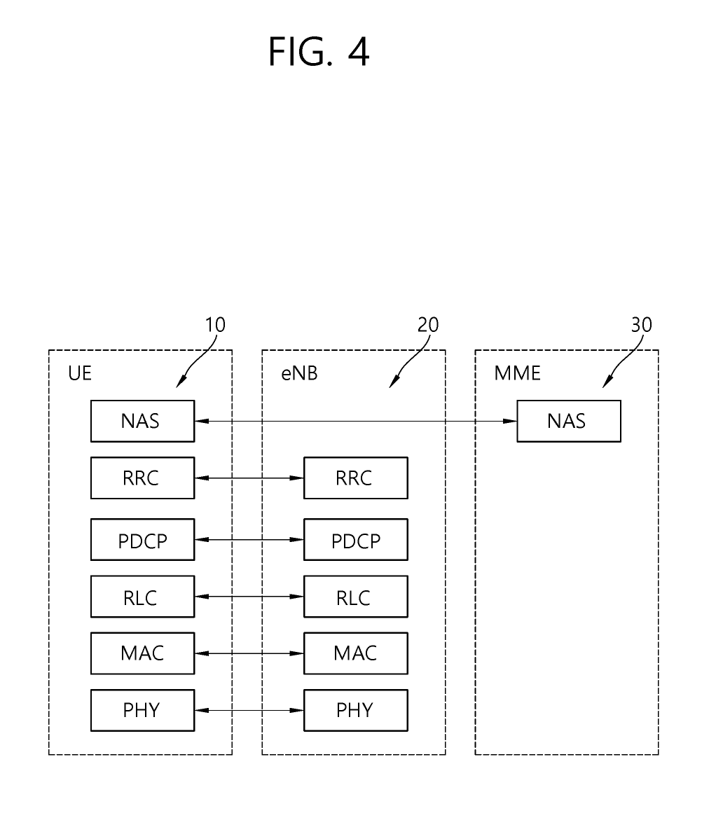

FIG. 3 shows a block diagram of a user plane protocol stack of an LTE system. FIG. 4 shows a block diagram of a control plane protocol stack of an LTE system. Layers of a radio interface protocol between the UE and the E-UTRAN may be classified into a first layer (L1), a second layer (L2), and a third layer (L3) based on the lower three layers of the open system interconnection (OSI) model that is well-known in the communication system.

A physical (PHY) layer belongs to the L1. The PHY layer provides a higher layer with an information transfer service through a physical channel. The PHY layer is connected to a medium access control (MAC) layer, which is a higher layer of the PHY layer, through a transport channel. A physical channel is mapped to the transport channel. Data between the MAC layer and the PHY layer is transferred through the transport channel. Between different PHY layers, i.e., between a PHY layer of a transmission side and a PHY layer of a reception side, data is transferred via the physical channel.

A MAC layer, a radio link control (RLC) layer, and a packet data convergence protocol (PDCP) layer belong to the L2. The MAC layer provides services to the RLC layer, which is a higher layer of the MAC layer, via a logical channel. The MAC layer provides data transfer services on logical channels. The RLC layer supports the transmission of data with reliability. Meanwhile, a function of the RLC layer may be implemented with a functional block inside the MAC layer. In this case, the RLC layer may not exist. The PDCP layer provides a function of header compression function that reduces unnecessary control information such that data being transmitted by employing IP packets, such as IPv4 or IPv6, can be efficiently transmitted over a radio interface that has a relatively small bandwidth.

A radio resource control (RRC) layer belongs to the L3. The RLC layer is located at the lowest portion of the L3, and is only defined in the control plane. The RRC layer controls logical channels, transport channels, and physical channels in relation to the configuration, reconfiguration, and release of radio bearers (RBs). The RB signifies a service provided the L2 for data transmission between the UE and E-UTRAN.

Referring to FIG. 3, the RLC and MAC layers (terminated in the eNB on the network side) may perform functions such as scheduling, automatic repeat request (ARQ), and hybrid ARQ (HARQ). The PDCP layer (terminated in the eNB on the network side) may perform the user plane functions such as header compression, integrity protection, and ciphering.

Referring to FIG. 4, the RLC and MAC layers (terminated in the eNB on the network side) may perform the same functions for the control plane. The RRC layer (terminated in the eNB on the network side) may perform functions such as broadcasting, paging, RRC connection management, RB control, mobility functions, and UE measurement reporting and controlling. The NAS control protocol (terminated in the MME of gateway on the network side) may perform functions such as a SAE bearer management, authentication, LTE_IDLE mobility handling, paging origination in LTE_IDLE, and security control for the signaling between the gateway and UE.

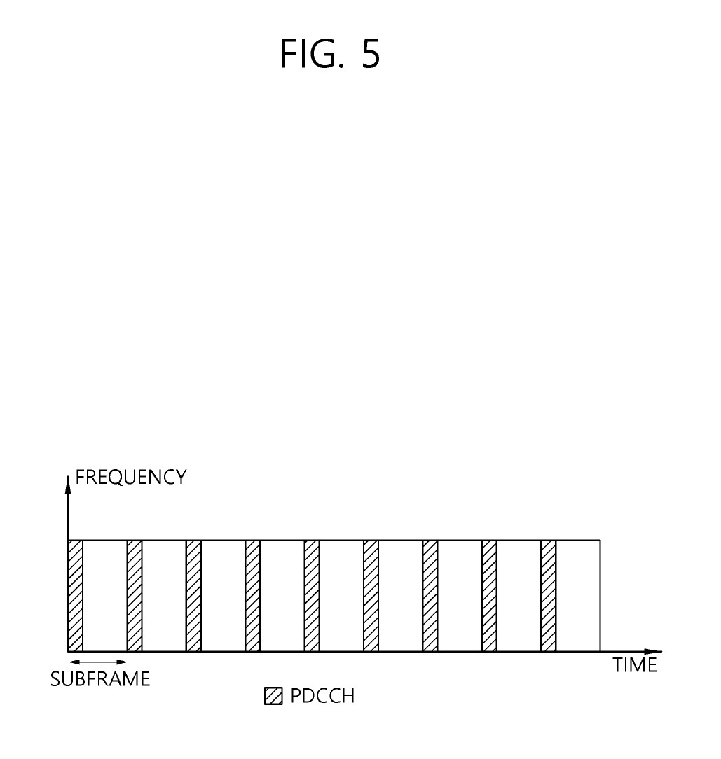

FIG. 5 shows an example of a physical channel structure. A physical channel transfers signaling and data between PHY layer of the UE and eNB with a radio resource. A physical channel consists of a plurality of subframes in time domain and a plurality of subcarriers in frequency domain. One subframe, which is 1 ms, consists of a plurality of symbols in the time domain. Specific symbol(s) of the subframe, such as the first symbol of the subframe, may be used for a physical downlink control channel (PDCCH). The PDCCH carries dynamic allocated resources, such as a physical resource block (PRB) and modulation and coding scheme (MCS).

A DL transport channel includes a broadcast channel (BCH) used for transmitting system information, a paging channel (PCH) used for paging a UE, a downlink shared channel (DL-SCH) used for transmitting user traffic or control signals, a multicast channel (MCH) used for multicast or broadcast service transmission. The DL-SCH supports HARQ, dynamic link adaptation by varying the modulation, coding and transmit power, and both dynamic and semi-static resource allocation. The DL-SCH also may enable broadcast in the entire cell and the use of beamforming.

A UL transport channel includes a random access channel (RACH) normally used for initial access to a cell, a uplink shared channel (UL-SCH) for transmitting user traffic or control signals, etc. The UL-SCH supports HARQ and dynamic link adaptation by varying the transmit power and potentially modulation and coding. The UL-SCH also may enable the use of beamforming.

The logical channels are classified into control channels for transferring control plane information and traffic channels for transferring user plane information, according to a type of transmitted information. That is, a set of logical channel types is defined for different data transfer services offered by the MAC layer.

The control channels are used for transfer of control plane information only. The control channels provided by the MAC layer include a broadcast control channel (BCCH), a paging control channel (PCCH), a common control channel (CCCH), a multicast control channel (MCCH) and a dedicated control channel (DCCH). The BCCH is a downlink channel for broadcasting system control information. The PCCH is a downlink channel that transfers paging information and is used when the network does not know the location cell of a UE. The CCCH is used by UEs having no RRC connection with the network. The MCCH is a point-to-multipoint downlink channel used for transmitting multimedia broadcast multicast services (MBMS) control information from the network to a UE. The DCCH is a point-to-point bi-directional channel used by UEs having an RRC connection that transmits dedicated control information between a UE and the network.

Traffic channels are used for the transfer of user plane information only. The traffic channels provided by the MAC layer include a dedicated traffic channel (DTCH) and a multicast traffic channel (MTCH). The DTCH is a point-to-point channel, dedicated to one UE for the transfer of user information and can exist in both uplink and downlink. The MTCH is a point-to-multipoint downlink channel for transmitting traffic data from the network to the UE.

Uplink connections between logical channels and transport channels include the DCCH that can be mapped to the UL-SCH, the DTCH that can be mapped to the UL-SCH and the CCCH that can be mapped to the UL-SCH. Downlink connections between logical channels and transport channels include the BCCH that can be mapped to the BCH or DL-SCH, the PCCH that can be mapped to the PCH, the DCCH that can be mapped to the DL-SCH, and the DTCH that can be mapped to the DL-SCH, the MCCH that can be mapped to the MCH, and the MTCH that can be mapped to the MCH.

An RRC state indicates whether an RRC layer of the UE is logically connected to an RRC layer of the E-UTRAN. The RRC state may be divided into two different states such as an RRC idle state (RRC_IDLE) and an RRC connected state (RRC_CONNECTED). In RRC_IDLE, the UE may receive broadcasts of system information and paging information while the UE specifies a discontinuous reception (DRX) configured by NAS, and the UE has been allocated an identification (ID) which uniquely identifies the UE in a tracking area and may perform public land mobile network (PLMN) selection and cell re-selection. Also, in RRC_IDLE, no RRC context is stored in the eNB.

In RRC_CONNECTED, the UE has an E-UTRAN RRC connection and a context in the E-UTRAN, such that transmitting and/or receiving data to/from the eNB becomes possible. Also, the UE can report channel quality information and feedback information to the eNB. In RRC_CONNECTED, the E-UTRAN knows the cell to which the UE belongs. Therefore, the network can transmit and/or receive data to/from UE, the network can control mobility (handover and inter-radio access technologies (RAT) cell change order to GSM EDGE radio access network (GERAN) with network assisted cell change (NACC)) of the UE, and the network can perform cell measurements for a neighboring cell.

In RRC_IDLE, the UE specifies the paging DRX cycle. Specifically, the UE monitors a paging signal at a specific paging occasion of every UE specific paging DRX cycle. The paging occasion is a time interval during which a paging signal is transmitted. The UE has its own paging occasion. A paging message is transmitted over all cells belonging to the same tracking area. If the UE moves from one tracking area (TA) to another TA, the UE will send a tracking area update (TAU) message to the network to update its location.

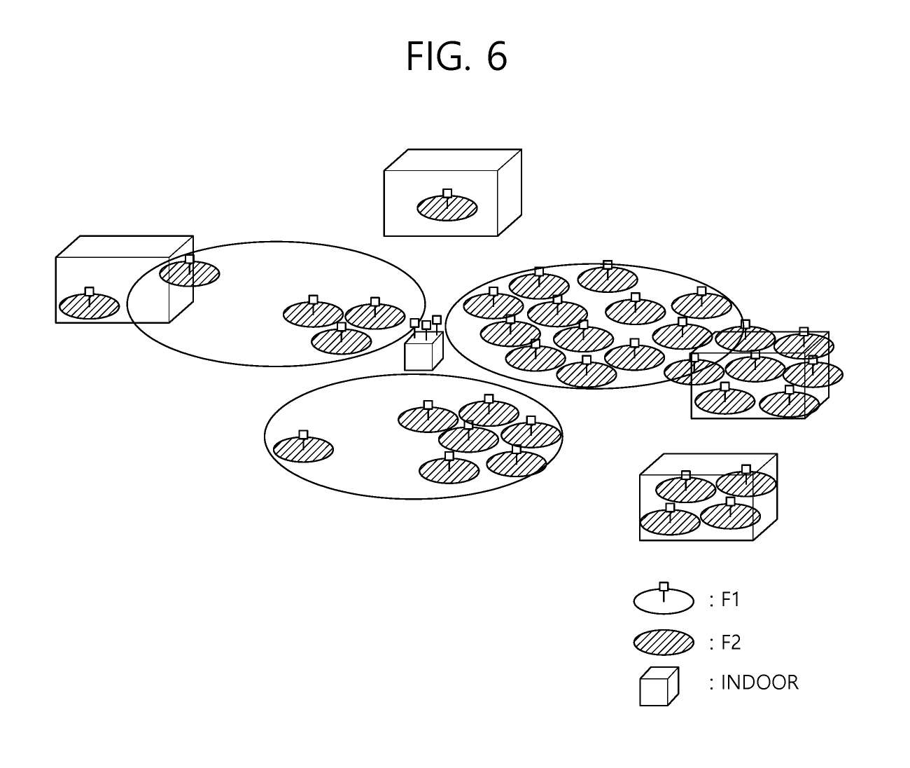

FIG. 6 shows deployment scenarios of small cells with/without macro coverage. Small cell enhancement should target both with and without macro coverage, both outdoor and indoor small cell deployments and both ideal and non-ideal backhaul. Both sparse and dense small cell deployments should be considered. Referring to FIG. 6, small cell enhancement should target the deployment scenario in which small cell nodes are deployed under the coverage of one or more than one overlaid E-UTRAN macro-cell layer(s) in order to boost the capacity of already deployed cellular network. Two scenarios can be considered:
where the UE is in coverage of both the macro cell and the small cell simultaneously
where the UE is not in coverage of both the macro cell and the small cell simultaneously.

Also, the deployment scenario where small cell nodes are not deployed under the coverage of one or more overlaid E-UTRAN macro-cell layer(s) may be considered.

For small cell enhancement, discussion is now ongoing on aspects of physical layer. In particular, in order to increase user packet throughput (UPT) of a UE and reduce interruption possibly occurring when every small cell is switched on in a case where a plurality of small cells are deployed in the coverage of a macro cell in 3GPP LTE rel-12, switching on/off a small cell is considered. For the increase in the UPT of the UE, a transit time which is the duration for the small cell to be switched on to off, or vice versa, should be within up to 100 ms.

Various technologies are discussed to support quick transit of the on/off state of a small cell, and one of them is a discovery signal. An off-state small cell transmits a discovery signal to let an UE discover the small cell itself. To enable the UE to receive a data packet which is to be transmitted to the UE when the small cell is switched to on state, the small cell may add, to the discovery signal, information necessary for procedures required to be performed before the small cell is switched to on state, and then transmit the discovery signal. How an off-state small cell transmits a discovery signal, what kind of information that needs to be included in the discovery signal, and/or how an UE measure the discovery signal are still under discussion.

Meanwhile, an UE discovers an off-state small cell in response to receipt of a discovery signal, and reports the discovery to a macro cell through the following procedures.

1. An UE receives, from a macro cell, information necessary to measure a discovery signal of an off-state small cell.

2. The off-state small cell transmits the discovery signal.

3. The UE measures the discovery signal transmitted by the off-state small cell.

4. When a particular condition is satisfied, the UE reports measurement results to the macro cell.

To perform the above procedures, the macro cell needs to check whether a small cell existing in its coverage supports a discovery signal. If the macro cell does not know about whether a small cell existing in its coverage supports a discovery signal, the information necessary for the UE to measure a discovery signal of the small cell received from the macro cell may be unnecessary, and the UE may unnecessarily waste battery power to search for the discovery signal based on the received information. In addition, the macro cell needs to be informed of information on a cycle of a discovery signal to be transmitted by a small cell existing in its coverage. A discovery signal to be transmitted by an off-state small cell may have a cycle longer than a cell-specific reference signal (CRS) in order to reduce interference to adjacent cells. If the macro cell is not informed of the cycle, the UE has to keep searching for the discovery signal, thereby consuming more battery. That is, various problems may occur because the macro cell is not informed of the information on the discovery signal to be transmitted by the small cell existing in its coverage.

To address the above problem, there is suggested a method according to an embodiment of the present invention, the method in which a small cell transmits, to a macro cell, information on a discovery signal to be transmitted by the small cell itself. More specifically, the small cell may transmit, to the macro cell, information on a cycle of a discovery signal to be transmitted by the small cell itself. The cycle of a discovery signal may be determined based on an offset value for a system frame number (SFN) of the small cell, or may be determined in consideration of delay of an X2 interface. In addition, the cycle of a discovery signal may drift little by little, so it needs to be periodically informed to the macro cell. As information on the cycle of a discovery signal to be transmitted by the small cell existing in the coverage of a macro cell is transmitted to the macro cell, the macro cell may be informed of the information on the cycle of the discovery signal and may inform an UE of the same information. Based on the received information on the cycle of the discovery signal, the UE may efficiently receive the discovery signal.

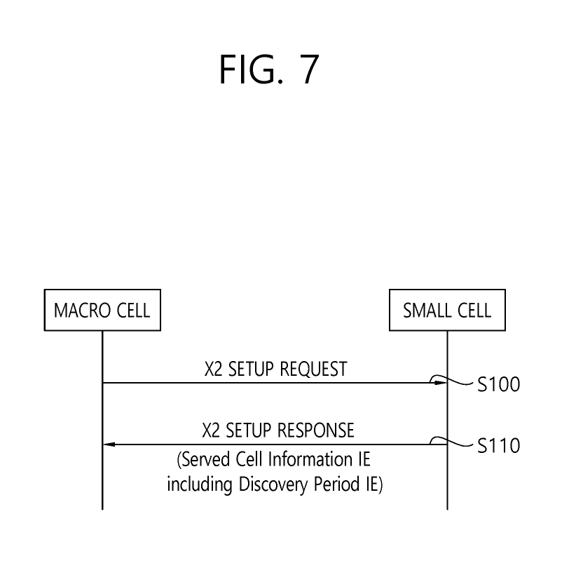

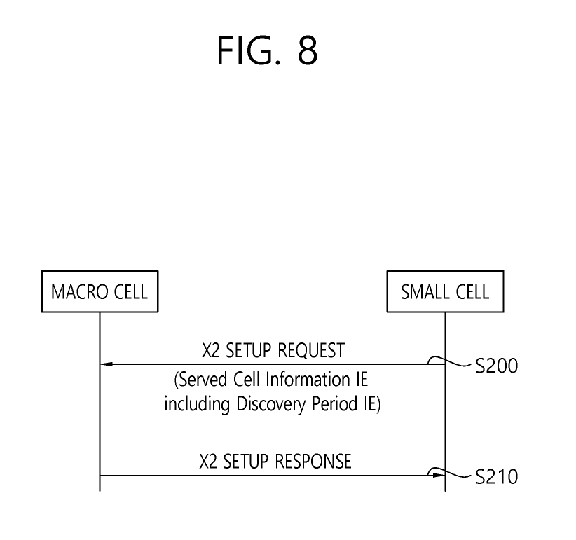

FIGS. 7 and 8 shows examples of a method for transmitting information on a cycle of a discovery signal according to an embodiment of the present invention. Using an X2 setup procedure shown in FIGS. 7 and 8, a small cell may inform a macro cell of information on a discovery signal to be transmitted by the small cell itself, when the small cell is deployed at first.

Referring to FIG. 7, a macro cell transmits an X2 setup request message to a macro cell in step S100. In step S110, the small cell transmits an X2 setup response message to the macro cell in response to the X2 setup request message. The X2 setup response message may include a Served Cell Information IE (information element) which may include Discovery Period IE. Discovery Period IE indicates information on a cycle of a discovery signal to be transmitted by the small cell.

Referring to FIG. 8, a small cell transmits an X2 setup request message to a macro cell in step S200. The X2 setup request message may include Served Cell Information IE which may include Discovery Period IE. Discovery Period IE indicates information on a cycle of a discovery signal to be transmitted by the small cell. In step S210, the macro cell transmits an X2 setup response message to the small cell in response to the X2 setup request message.

Table 1 shows an example of Served Cell Information IE that is included in an X2 setup request or response message according to an embodiment of the present invention.

TABLE 1

| | | | IE type and | Semantics | | Assigned |
|---|---|---|---|---|---|---|
| IE/Group Name | Presence | Range | reference | description | Criticality | Criticality |
| PCI | M | | INTEGER | Physical | — | — |
| | | | (0 . . . 503, . . .) | Cell ID | | |
| Cell ID | M | | ECGI | | — | — |
| | | | 9.2.14 | | | |
| TAC | M | | OCTET | Tracking | — | — |
| | | | STRING(2) | Area Code | | |
| Broadcast PLMNs | | 1 . . . | | Broadcast | — | — |
| | | <maxnoofBPLMNs> | | PLMNs | | |
| >PLMN Identity | M | | 9.2.4 | | — | — |
| CHOICE EUTRA- | M | | | | — | — |
| Mode-Info | | | | | | |
| >FDD | | | | | | |
| >>FDD Info | | 1 | | | — | — |
| >>>UL EARFCN | M | | EARFCN | Corresponds to | — | — |
| | | | 9.2.26 | N_{UL} in TS 36.104 | | |
| | | | | [16] for E-UTRA | | |
| | | | | operating bands | | |
| | | | | for which it is | | |
| | | | | defined; ignored | | |
| | | | | for E-UTRA oper- | | |
| | | | | ating bands for | | |
| | | | | which N_{UL} is not | | |
| | | | | defined | | |
| >>>DL EARFCN | M | | EARFCN | Corresponds to | — | — |
| | | | 9.2.26 | N_{DL} in TS 36.104 | | |
| | | | | [16] | | |
| >>>UL Transmission | M | | Transmission | Same as DL | — | — |
| Bandwidth | | | Bandwidth | Transmission | | |
| | | | 9.2.27 | Bandwidth in | | |
| | | | | this release; | | |
| | | | | ignored in case | | |
| | | | | UL EARFCN | | |
| | | | | value is ignored | | |
| >>>DL Transmission | M | | Transmission | | — | — |
| Bandwidth | | | Bandwidth | | | |
| | | | 9.2.27 | | | |
| >>>UL EARFCN | O | | EARFCN | If this IE is | YES | reject |
| Extension | | | Extension | present, the | | |
| | | | 9.2.65 | value signalled | | |
| | | | | in the UL | | |
| | | | | EARFCN IE | | |
| | | | | is ignored. | | |
| >>>DL EARFCN | O | | EARFCN | If this IE is | YES | reject |
| Extension | | | Extension | present, the | | |
| | | | 9.2.65 | value signalled | | |
| | | | | in the DL | | |
| | | | | EARFCN IE | | |
| | | | | is ignored. | | |
| >TDD | | | | | — | — |
| >>TDD Info | | 1 | | | — | — |
| >>>EARFCN | M | | 9.2.26 | Corresponds to | — | — |
| | | | | N_{DL}/N_{UL} in TS | | |
| | | | | 36.104 [16] | | |
| >>>Transmission | M | | Transmission | | — | — |
| Bandwidth | | | Bandwidth | | | |
| | | | 9.2.27 | | | |
| >>>Subframe | M | | ENUMERATED(sa0, | Uplink-down- | — | — |
| Assignment | | | sa1, sa2, sa3, sa4, | link subframe | | |
| | | | sa5, sa6, . . .) | configuration | | |
| | | | | information | | |
| | | | | defined in TS | | |
| | | | | 36.211 [10] | | |
| >>>Special Subframe | | 1 | | Special subframe | — | — |
| Info | | | | configuration | | |
| | | | | information | | |
| | | | | defined in TS | | |
| | | | | 36.211 [10] | | |
| >>>>Special Subframe | M | | ENUMERATED(ssp0, | | — | — |
| Patterns | | | ssp1, ssp2, ssp3, | | | |
| | | | ssp4, ssp5, ssp6, | | | |
| | | | ssp7, ssp8, . . .) | | | |
| >>EARFCN Extension | O | | 9.2.65 | If this IE is | YES | reject |
| | | | | present, the | | |
| | | | | value signalled | | |
| | | | | in the EARFCN | | |
| | | | | IE is ignored. | | |
| >>>>Cyclic Prefix DL | M | | ENUMERATED(Normal, | | — | — |
| | | | Extended, . . .) | | | |
| >>>>Cyclic Prefix UL | M | | ENUMERATED(Normal, | | — | — |
| | | | Extended, . . .) | | | |
| >>>Additional Special | O | | | Special subframe | GLOBAL | ignore |
| Subframe Info | | | | configuration | | |
| | | | | information | | |
| | | | | defined in TS | | |
| | | | | 36.211 [10]. | | |
| | | | | Only for newly | | |
| | | | | defined configu- | | |
| | | | | ration of special | | |
| | | | | subframe from | | |
| | | | | Release 11. | | |
| >>>>Additional | M | | ENUMERATED(ssp0, | | — | — |
| Special Subframe | | | ssp1, ssp2, ssp3, | | | |
| Patterns | | | ssp4, ssp5, ssp6, | | | |
| | | | ssp7, ssp8, ssp9, . . .) | | | |
| >>>>Cyclic Prefix DL | M | | ENUMERATED(Normal, | | — | — |
| | | | Extended, . . .) | | | |
| >>>>Cyclic Prefix UL | M | | ENUMERATED(Normal, | | — | — |
| | | | Extended, . . .) | | | |
| Number of Antenna | O | | 9.2.43 | | YES | ignore |
| Ports | | | | | | |
| PRACH Configuration | O | | PRACH Configuration | | YES | ignore |
| | | | 9.2.50 | | | |

Referring to Table 1, Served Cell Information IE includes Discovery Period IE. Discovery Period 1E indicates a transmission cycle of a discovery signal. Accordingly, information on the cycle of the discovery signal may be transmitted to a macro cell.

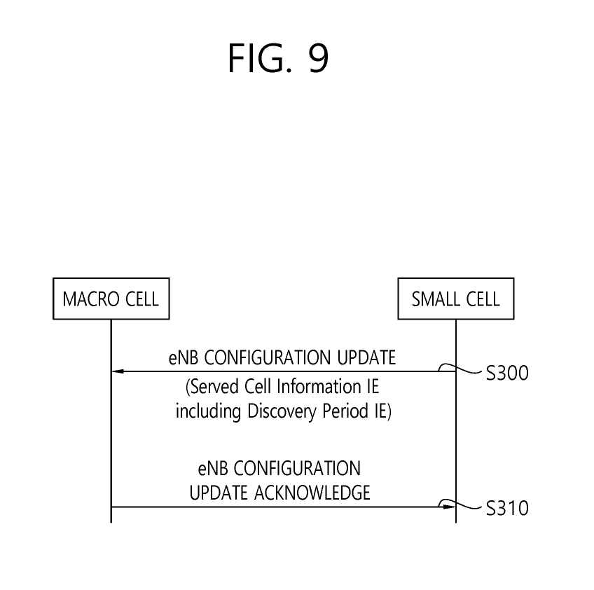

FIG. 9 shows another example of a method for transmitting information on a cycle of a discovery signal according to an embodiment of the present invention. Using an eNB configuration update procedure shown in FIG. 9, after a small cell establishes X2 connection to a macro cell, the small cell may periodically inform the macro cell of information on a discovery signal to be transmitted by the small cell itself. Referring to FIG. 9, a small cell transmits an eNB configuration update message to a macro cell in step S300. The eNB configuration update message may include Served Cell Information IE which may include Discovery Period IE. Discovery Period IE indicates information on a cycle of a discovery signal to be transmitted by the small cell. This may be referred to Table 1. In step S310, the macro cell transmits an eNB configuration update acknowledge message to the small cell in response to the eNB configuration update message.

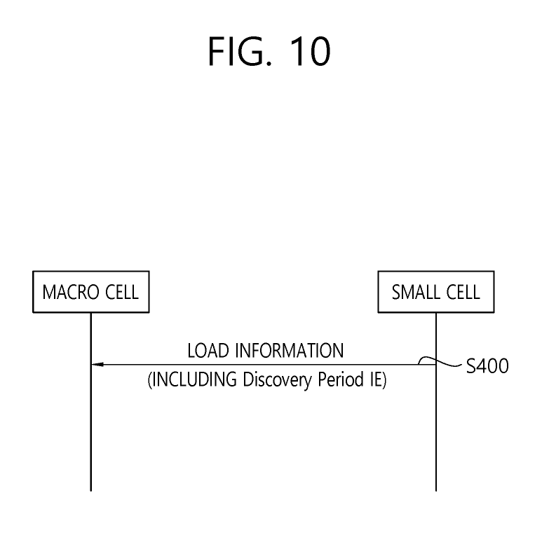

FIG. 10 shows another embodiment of a method for transmitting information on a cycle of a discovery signal according to an embodiment of the present invention. Using a load indication procedure shown in FIG. 10, after a small cell establishes X2 connection to a macro cell, the small cell may periodically inform the macro cell information on a discovery signal to be transmitted by the small cell itself. Referring to FIG. 10, the small cell transmits a load information message to the macro cell in step S400. The load information message may include Discovery Period IE that indicates information on a cycle of the discovery signal to be transmitted by the small cell. Table 2 shows an example of a load information message according to an embodiment of the present invention.

TABLE 2

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | ignore |
| Cell Information | M | | | | YES | ignore |
| >Cell Information Item | | 1 . . . | | | EACH | ignore |
| | | <maxCellineNB> | | | | |
| >>Cell ID | M | | ECGI | Id of the | — | — |
| | | | 9.2.14 | source cell | | |
| >>UL Interference | O | | 9.2.17 | | — | — |
| Overload Indication | | | | | | |
| >>UL High | | 0 . . . | | | — | — |
| Interference | | <maxCellineNB> | | | | |
| Information | | | | | | |
| >>>Target Cell ID | M | | ECGI | Id of the cell | — | — |
| | | | 9.2.14 | for which the | | |
| | | | | HII is meant | | |
| >>>UL High | M | | 9.2.18 | | — | — |
| Interference Indication | | | | | | |
| >>Relative | O | | 9.2.19 | | — | — |
| Narrowband Tx Power | | | | | | |
| (RNTP) | | | | | | |
| >>ABS Information | O | | 9.2.54 | | YES | ignore |
| >>Discovery Period | O | | | Indicate the | YES | ignore |
| | | | | period that | | |
| | | | | discovery signal | | |
| | | | | is transmitted | | |
| >>Invoke Indication | O | | 9.2.55 | | YES | ignore |

Referring to Table 2, a load information message includes Discovery Period IE. Discovery Period IE indicates a transmission cycle of a discovery signal. Accordingly, information on the cycle of the discovery signal may be transmitted to a macro cell.

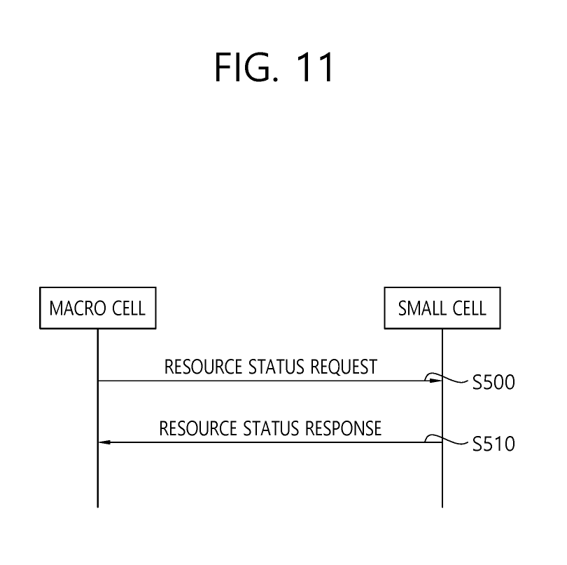

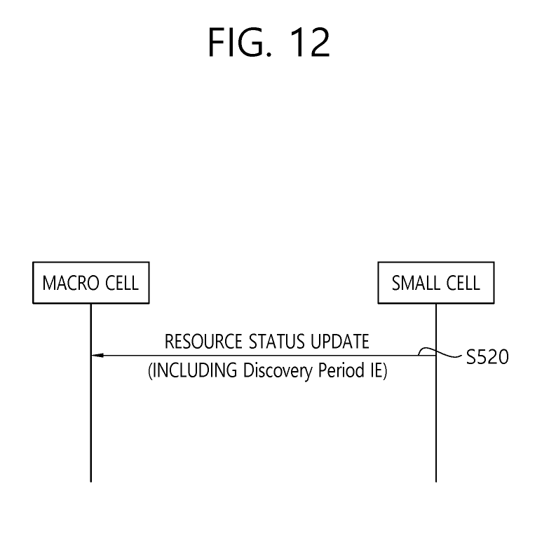

FIGS. 11 and 12 shows another examples of a method for transmitting information on a cycle of a discovery signal according to an embodiment of the present disclosure. Using a resource status report initiation procedure shown in FIG. 11 and a resource status report procedure shown in FIG. 12, after a small cell establishes X2 connection to a macro cell, the small cell may periodically inform the macro cell of information on a discovery signal to be transmitted by the small cell itself.

Referring to FIG. 11, a macro cell transmits a resource status request message to a small cell in step S500. Using the resource status request message, the macro cell may request that the small cell updates information on a cycle of a discovery signal to be transmitted by the small cell itself. In step S510, the small cell transmits a resource status response message to the macro cell in response to the resource status request message. Table 3 shows an example of a resource status request message according to an embodiment of the present invention.

TABLE 3

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Measurement | M | | INTEGER | Allocated | YES | reject |
| ID | | | (1 . . . 4095, . . .) | by eNB₁ | | |
| eNB2 Measurement | C- | | INTEGER | Allocated | YES | ignore |
| ID | ifRegistra- | | (1 . . . 4095, . . .) | by eNB₂ | | |
| | tionRe- | | | | | |
| | questStop | | | | | |
| Registration Request | M | | ENUMERATED(start, | A value set to “stop”, | YES | reject |
| | | | stop, . . .) | indicates a request | | |
| | | | | to stop all cells | | |
| | | | | measurements. | | |
| Report Characteristics | O | | BITSTRING | Each position in the | YES | reject |
| | | | (SIZE(32)) | bitmap indicates | | |
| | | | | measurement object | | |
| | | | | the eNB₂ is requested | | |
| | | | | to report. | | |
| | | | | First Bit = PRB Periodic, | | |
| | | | | Second Bit = TNL load | | |
| | | | | Ind Periodic, | | |
| | | | | Third Bit = HW Load | | |
| | | | | Ind Periodic, | | |
| | | | | Fourth Bit = Composite | | |
| | | | | Available Capacity | | |
| | | | | Periodic, | | |
| | | | | Fifth Bit = ABS Status | | |
| | | | | Periodic. | | |
| | | | | Sixth Bit = Discovery | | |
| | | | | Period Periodic. | | |
| | | | | Other bits shall be | | |
| | | | | ignored by the eNB₂. | | |
| Cell To Report | | 1 | | Cell ID list for | YES | ignore |
| | | | | which measurement | | |
| | | | | is needed | | |
| >Cell To Report Item | | 1 . . . | | | EACH | ignore |
| | | <maxCellineNB> | | | | |
| >>Cell ID | M | | ECGI | | — | — |
| | | | 9.2.14 | | | |
| Reporting Periodicity | O | | ENUMERATED(1000 | | YES | ignore |
| | | | ms, 2000 ms, 5000 | | | |
| | | | ms, 10000 ms, . . .) | | | |
| Partial Success | O | | ENUMERATED(partial | Included if partial | YES | ignore |
| Indicator | | | success allowed, . . .) | success is allowed | | |

Referring to Table 3, a resource status request message includes Report Characteristics IE, and each bit of Report Characteristics IE indicates a target of measurement that an eNB is required to report. The sixth bit of Report Characteristics IE indicates “Discovery Period Periodic” which indicates that a transmission cycle of a discovery signal needs to be periodically transmitted.

Referring to FIG. 12, a small cell transmits a resource status update message to a macro cell in step S520. The resource status update message may include Discovery Period IE. Discovery Period IE indicates information on a cycle of a discovery signal to be transmitted by the small cell. Table 4 shows an example of a load information message according to an embodiment of the present invention.

TABLE 4

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | ignore |
| eNB1 Measurement | M | | INTEGER | Allocated | YES | reject |
| ID | | | (1 . . . 4095, . . .) | by eNB₁ | | |
| eNB2 Measurement | M | | INTEGER | Allocated | YES | reject |
| ID | | | (1 . . . 4095, . . .) | by eNB₂ | | |
| Cell Measurement | | 1 | | | YES | ignore |
| Result | | | | | | |
| >Cell Measurement | | 1 . . . | | | EACH | ignore |
| Result Item | | <maxCellineNB> | | | | |
| >>Cell ID | M | | ECGI | | | |
| | | | 9.2.14 | | | |
| >>Hardware Load | O | | 9.2.34 | | | |
| Indicator | | | | | | |
| >>S1 TNL Load | O | | 9.2.35 | | | |
| Indicator | | | | | | |
| >>Radio Resource | O | | 9.2.37 | | | |
| Status | | | | | | |
| >>Composite | O | | 9.2.44 | | YES | ignore |
| Available Capacity | | | | | | |
| Group | | | | | | |
| >>ABS Status | O | | 9.2.58 | | YES | ignore |
| >>Discovery Period | O | | 9.2.xx | | YES | ignore |

TABLE 5

| IE/Group | | | IE type and | |
|---|---|---|---|---|
| Name | Presence | Range | reference | Semantics description |
| Discovery | M | | | Indicate the period |
| Period | | | | that discovery signal is |
| | | | | transmitted |

Referring to Tables 4 and 5, a resource status update message includes Discovery Period 1E. Discovery Period IE indicates a transmission cycle of a discovery signal. Accordingly, information on the cycle of the discovery signal may be transmitted to the macro cell.

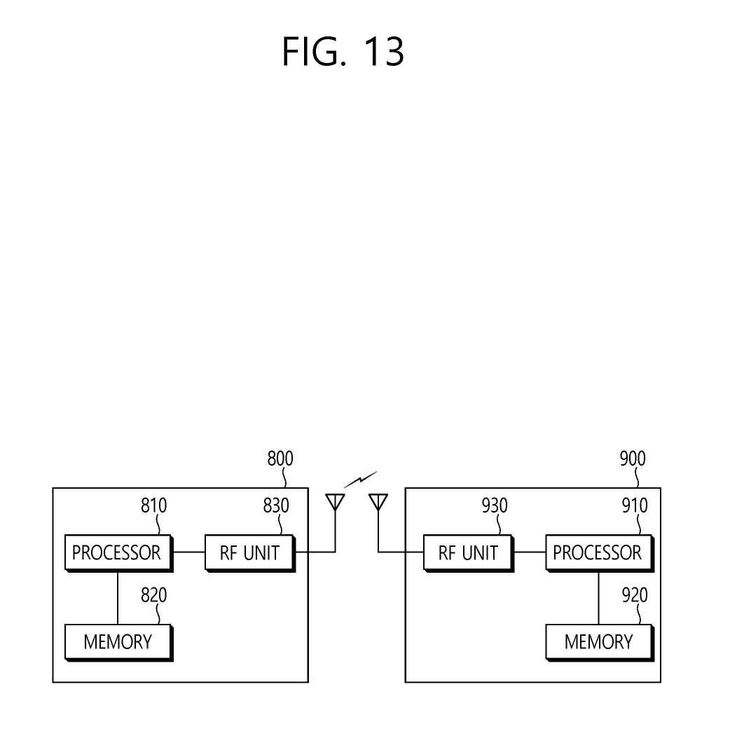

FIG. 13 shows a block diagram of a wireless communication system to implement an embodiment of the present invention.

An eNB of a macro cell 800 includes a processor 810, a memory 820, and a radio frequency (RF) unit 830. The processor 810 may be configured to implement proposed functions, procedures, and/or methods in this description. Layers of the radio interface protocol may be implemented in the processor 810. The memory 820 is operatively coupled with the processor 810 and stores a variety of information to operate the processor 810. The RF unit 830 is operatively coupled with the processor 810, and transmits and/or receives a radio signal.

An eNB of a small cell 900 includes a processor 910, a memory 920 and an RF unit 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The RF unit 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The RF units 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for transmitting information on a cycle of a discovery signal to be transmitted by a small cell in a wireless communication system, the method comprising:
transmitting the information on the cycle of the discovery signal to a macro cell; and
transmitting the discovery signal according to the cycle of the discovery signal.

2. The method of claim 1, wherein the cycle of the discovery signal is determined based on an offset value for a system frame number (SFN) of the small cell.

3. The method of claim 1, wherein the cycle of the discovery signal is determined based on delay of an X2 interface.

4. The method of claim 1, wherein the information on the cycle of the discovery signal is transmitted via an X2 setup request message or an X2 setup response message when the small cell establishes X2 connection to the macro cell.

5. The method of claim 4, wherein the information on the cycle of the discovery signal is included in a Served Cell Information IE (information element) within the X2 setup request message or the X2 setup response message.

6. The method of claim 1, wherein the information on the cycle of the discovery signal is periodically transmitted via an evolved NodeB (eNB) configuration update message.

7. The method of claim 6, wherein the information on the cycle of the discovery signal is included in a Served Cell Information IE within the eNB configuration update message.

8. The method of claim 1, wherein the information on the cycle of the discovery signal is periodically transmitted via a load information message.

9. The method of claim 1, wherein the information on the cycle of the discovery signal is periodically transmitted via a resource status update message.

10. The method of claim 9, further comprising receiving, from the macro cell, a request for the information on the cycle of the discovery signal.

11. The method of claim 10, wherein the request for the information on the cycle of the discovery signal is received via a resource status request message.

12. An evolved NodeB (eNB) of a small cell, which transmits information on a cycle of a discovery signal in a wireless communication system, the eNB comprising:
a radio frequency (RF) unit configured to transmit and receive a wireless signal; and
a processor connected to the RF unit,
wherein the processor is configured to:
transmit the information on the cycle of the discovery signal to a macro cell; and
transmit the discovery signal according to the cycle of the discovery signal.

13. The eNB of claim 12, wherein the cycle of the discovery signal is determined based on an offset value for a system frame number (SFN) of the small cell.

14. The eNB of claim 12, wherein the cycle of the discovery signal is determined based on delay of an X2 interface.

15. The eNB of claim 12, wherein the information on the cycle of the discovery signal is transmitted via one of an X2 setup request message, an X2 setup response message, an eNB configuration update message, a load information message, and a resource status update message.
